(19) United States
(12) Patent Application Publication
(10) Pub. No.: US 2008/0178135 A1
(43) Pub. Date: Jul. 24, 2008

(54) CELLS OF INTEGRATED CIRCUIT AND RELATED TECHNOLOGY AND METHOD

(75) Inventors: Jeng-Huang Wu, Hsinchu (TW); Sheng-Hua Chen, Kaohsiung (TW); Meng-Jer Wey, Hsinchuu (TW)

Correspondence Address: WPAT, PC, 7225 BEVERLY ST., ANNANDALE, VA, 22003, US

(73) Assignee: FARADAY TECHNOLOGY CORPORATION, Hsinchu (TW)

(21) Appl. No.: 11/829,870

(22) Filed: Jul. 27, 2007

(30) Foreign Application Priority Data
Jan. 19, 2007 (TW) 096102157

(51) Int. Cl. G06F 17/50

(52) U.S. Cl. 716/8

(57) ABSTRACT

Electronic cells/cell library and related technology/method capable of achieving high integration of integrated circuits. In one embodiment, the proposed technology adopts cells with cell heights equal to a non-integer multiplication of the routing track to establish a cell library, so a layout area of each cell is reduced. Further, higher integration of integrated circuit can be achieved by applying the proposed cells in integrated circuits.

### FIELD OF THE INVENTION

This invention relates to circuitry cells/cell library and corresponding methods and technology; more particularly, to circuitry cells/cell library and corresponding methods and technology with cell height equal to non-integer multiplication of the routing track.

### BACKGROUND OF THE INVENTION

Integrated circuits/chips have become one of the most important hardware infrastructures of modern society. Integrated circuits (ICs) and chips like Application Specific Integrated Circuit (ASIC) and System On a Chip (SOC) have been widely used in various electronic devices.

Generally speaking, because complex functionalities have to be implemented in modern (ICs), usually a pre-built cell library is required for providing rich circuit design resources. The cell library includes various basic circuitry cells. For example, a digital cell library includes cells such as various kinds of flip-flops and logic gates. Selecting and combining/connecting appropriate cells from the cell library, then a complete digital IC with desired functionalities can be established.

Because cells are basic building blocks of ICs, layout of the whole IC depends on layout of every cell. Furthermore, layout of every cell is closely related to semiconductor process applied for the cells/ICs. It is well known that different processes have design rules of different scales. For example, the minimal allowable interval between two parallel routings is one of the most important design rules. In high accuracy deep sub-micron process (e.g., a 90 nm process), interval between two parallel routings can be shorter. On the other hand, a process of larger scale (e.g., a 0.13 μm process), interval between two parallel routings must be longer to keep routings away of each other, or they can be erroneously short together.

Since the design rules are so important, the design rules are integrated into IC design flow to provide a routing design guideline and to assure that design rules are followed. More specifically, a routing track can be derived from the minimal allowable interval between two parallel routings, and a virtual routing track grid can be built based on the routing track, then a designer can arrange layout outlines and routings of cells following the routing track grid.

Please refer to FIGS. 1 and 2; FIGS. 1 and 2 illustrate two kinds of layout outlines of prior art cells. In FIGS. 1 and 2, a basic length La represents a routing track (one multiplication of the routing track); then a virtual routing track grid GO can be built with a plurality of grid lines g0, g1, g2, etc., wherein two adjacent parallel grid lines are separated by the basic length La. In FIG. 1, outline OLa represents a layout outline of a prior art cell, and a height Ha is the height of this cell. Just as FIG. 1 shows, the prior art respectively align top and bottom edges of a cell to two grid lines of routing track grid G0. Therefore, in this prior art, the cell height Ha of the cell equals an integer multiplication of the basic length La. Note that the cell has two power routings for transmitting bias power, and these power routings are respectively placed along top edge and bottom edge of a cell. In other words, a distance between power routings at top and bottom edges can also represent a height of a cell.

On the other hand, outline OLb shown in FIG. 2 represents another kind of layout outline of prior art cell. In this prior art, both the top edge and bottom edge of a cell are shifted from respective gridlines by an offset La/2. Again, in this prior, cell height Hb of a cell equals an integer multiplication of the basic length La.

As shown in FIGS. 1 and 2, prior art design criterion determines cell heights by integer multiplication of the routing track. However, this design routine leads to larger cell layout and thus lower integration of ICs.

### SUMMARY OF THE INVENTION

One object of the invention is providing a method for establishing (including designing and manufacturing) a circuitry cell, the method includes: determining a basic length L according to semiconductor process applied for the cell (for example, length L can equal a routing track), and making a layout height of the cell equal to a non-integer multiplication of the basic length L. In a preferred embodiment, the cell height is an odd-integer (odd-number) multiplication of L/2. More practically, the invention can be implemented as: first building a routing track grid according to the basic length L such that the routing track grid has a plurality of grid lines with interval between adjacent grid lines equal to the basic length L; aligning a bottom edge of a layout of the cell to one of the plurality of grid lines, and shifting a top edge of the layout of the cell from another one of the plurality of grid lines by an offset which is shorter than the basic length L (preferably an offset equal to L/2). In this way, the cell height becomes a non-integer multiplication of the basic length L. In another embodiment, the cell has its top edge aligning a grid line and bottom edge shifted from another grid line, and similarly the cell height is a non-integer multiplication of the basic length L. Another object of the invention is to establishing a cell library with cells of different functionalities; each cell is established following above design criterion to have a cell height of non-integer multiplication of the routing track.

Still another object of the invention is providing a cell. As previously discussed, a layout outline of a cell defines a substrate range for covering semiconductor structures of the cell. These semiconductor structures include (but are not limited to) various active regions formed by different doping wells, gate oxide, field oxide and/or STI (shallow trench isolation), contacts, metal layer routings, vias, etc. And in the invention, a height of the substrate range (e.g., distance between two power routings along two edges of the cell) is a non-integer multiplication of the routing track.

Because the invention makes cell height equal to a non-integer multiplication of the routing track, layout area of a cell can be effectively reduced. For example, a prior art cell height is 7 routing tracks; on the contrary, cell height of the invention can be reduced to 6.5 routing tracks to gain approximate 7% reduction in layout area (under the condition of identical cell widths). Therefore, building an IC with cells/cell library of the invention can effectively raise chip integration, reduce IC layout area requirement.

The above contents of the present invention will become more readily apparent to those ordinarily skilled in the art after reviewing the following detailed description and accompanying drawings, in which:

### BRIEF DESCRIPTION OF THE DRAWINGS

FIGS. 1 and 2 respectively illustrate two kinds of cell layout outlines according to prior art.

FIG. 3 shows a cell layout embodiment according to the invention.

FIG. 4 shows an embodiment for arranging power routings of FIG. 3.

FIG. 5 illustrates another cell layout embodiment according to the invention.

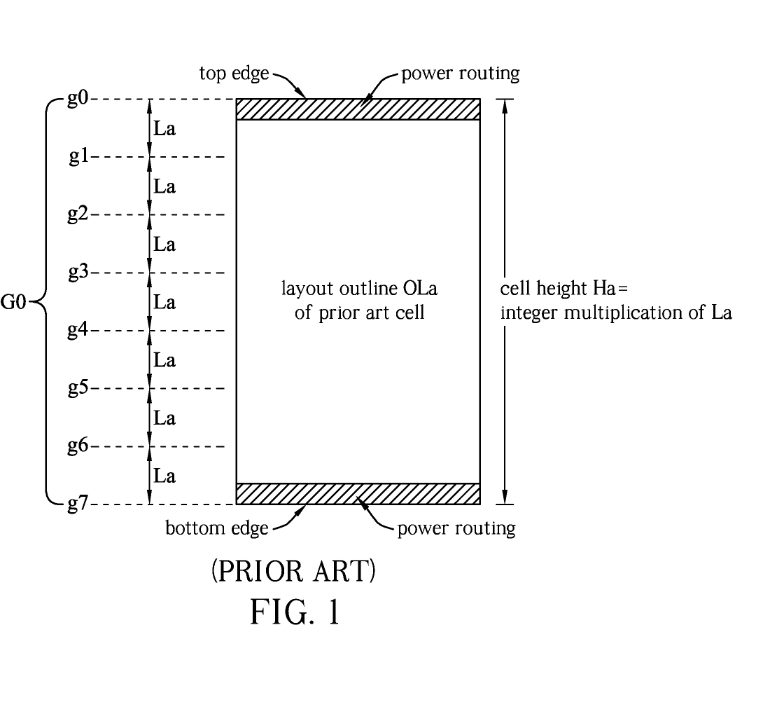

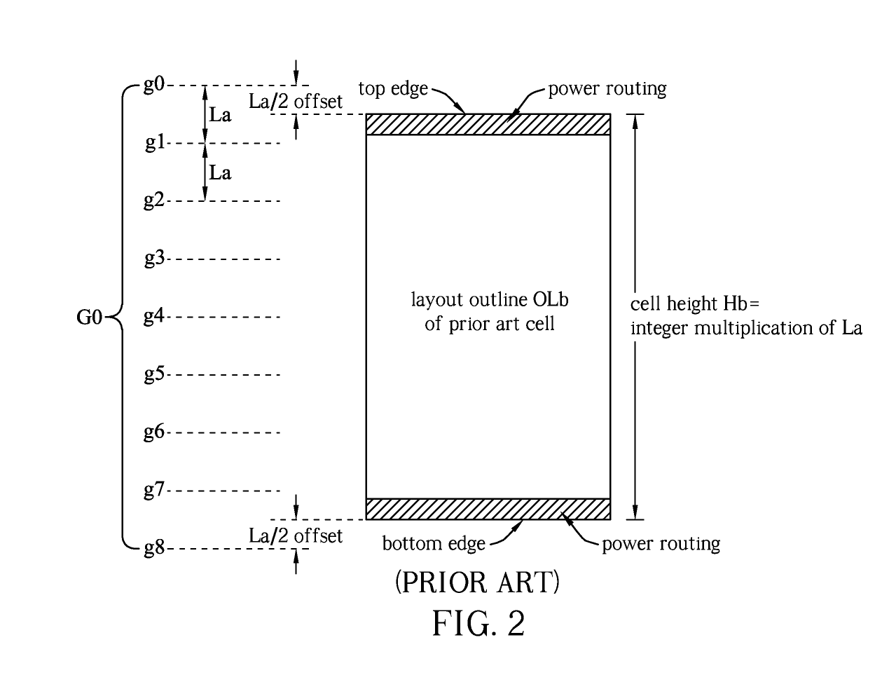

### DETAILED DESCRIPTION OF THE PREFERRED EMBODIMENT

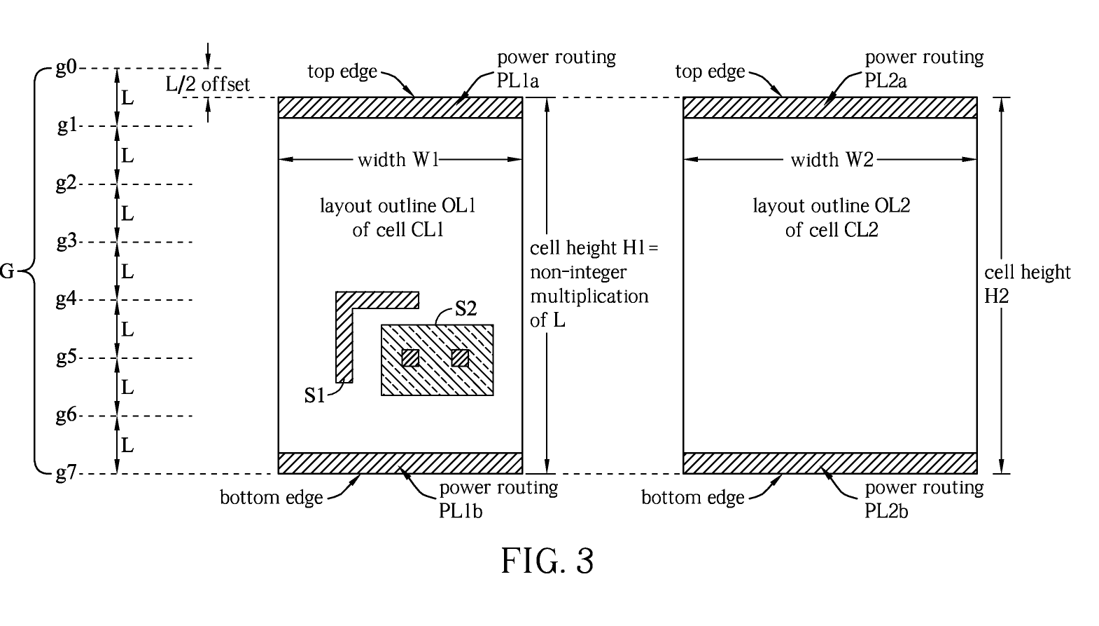

Please refer to FIG. 3; FIG.3 illustrates cells, cell library and related techniques according to a first embodiment of the invention. While establishing (designing and implementing) a circuitry cell, the invention first determines a basic length L according to semiconductor process applied for the cell. For example, a routing track can be derived from a minimal allowable routing interval ruled in design rules of the process, and the basic length L can be set equal to the routing track. According to the basic length L, a virtual routing track grid G can be built, which includes a plurality of grid lines (e.g., grid line g0-g7 shown in FIG. 3) with an interval between adjacent grid lines equal to the basic length L. When defining layout outline of a cell, the invention can make a layout height of a cell equal to a non-integer multiplication of the basic length L according to these grid lines. In the embodiment shown in FIG. 3, a layout outline OL1 of a cell CL1 is defined by aligning its bottom to one of the plurality of grid lines (e.g., grid line g7), and shifting a top edge of the outline OL1 from another grid line (e.g., grid line g0) by an offset shorter than the basic length L (preferably an offset equal to L/2). In this way, a layout height (also a cell height) H1 of the cell CL1 is set to a non-integer multiplication of the basic length L (preferably an odd-integer multiplication of half of the basic length, i.e., L/2).

While the outline OL1 and the height H1 of the cell CL1 are determined, layouts of semiconductor structures (like semiconductor structures S1, S2 shown in FIG. 3) can be arranged into the outline. For example, if the cell CL1 is a logic gate or a flip-flop, semiconductor structures like active regions and/or contacts can be used to form one or more p-type and/or n-type MOS transistors, and semiconductor structures like vias and metal (metal layer) routings are applied to connecting these transistors, then the circuitry functionality of the cell can be organized. While designing the metal routings, a designer can also arrange the routings aligning grid lines of the routing track grid G to ensure the design rule is followed.

To transmit bias power to the cell CL1, at least two power routings PL1a and PL1b are applied in the cell CL1. As an example, the power routings PL1a and PL1b are arranged aligning the top edge and bottom edge of the outline OL1 for transmitting positive bias and ground bias respectively. Thus, the distance between the parallel power routings PL1a and PL1b equivalently defines the height H1 of the cell CL1.

After the outline OL1 and the layouts of the semiconductor structures are arranged, a substrate range covering the layouts of the semiconductor structures is equivalently defined, and an actual cell can be implemented by the semiconductor process.

Because the cell height of the invention is set to a non-integer multiplication of the basic length L (e.g., a routing track), layout area of cells can be effectively reduced. For example, a normal prior art cell has a height of 7 routing tracks. On the other hand, a cell of the invention can has a reduced height of 6.5 routing tracks, and a layout area reduction of approximate 7% is gained (under the condition of same cell widths).

By applying the aforementioned design criterion of the invention, various cells can be designed to have cell heights of a non-integer multiplication of the routing tracks. As shown in FIG. 3, another cell CL2 can be established according to the invention, that is, a layout outline OL2 of the cell CL2 can have a bottom edge aligning the grid line g7 and a top edge shifted from the grid line g0. Then a cell height H2 of the cell CL2 is also a non-integer multiplication of the basic length L (preferably an odd-integer multiplication of L/2). Similarly, the cell CL2 can have power routings PL2a and PL2b respectively following the top and bottom edges. As FIG. 3 illustrates, the top/bottom edges of the cell CL1 and the top/bottom edges of the cell CL2 can be aligned (however the cell width WI of the cell CL1 can be different from the cell width W2 of the cell CL2). Thus the cells CL1 and CL2 can be used side by side with power routings PL1a/PL1b and PL2a/PL2b connected.

By collecting various cells with cell heights of a non-integer multiplication of the routing track according to the design criterion of the invention, a cell library is established to provide IC design resource. Since the cell heights of the invention are reduced, the ICs implemented using the cell library of the invention can have higher integration and/or lower layout areas.

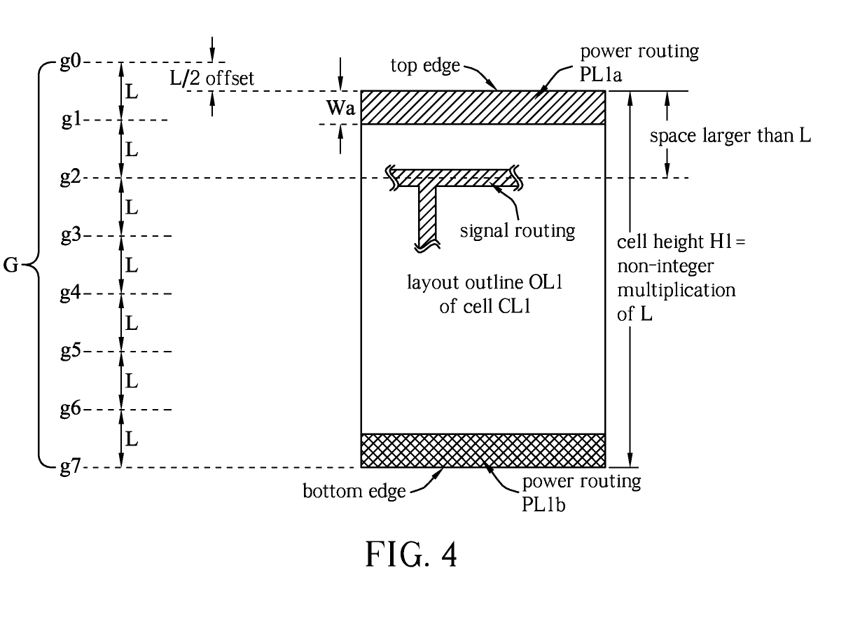

Following the embodiment of FIG. 3, please refer to FIG. 4; FIG. 4 illustrates how power routings (also known as follow pins) can be arranged according to an embodiment of the invention. In this embodiment of FIG. 4, because the top edge of the cell CL1 is shifted from the grid line g0, the power routing PL1a can have a wider metal layer layout with still enough room for another normal signal routing of the same metal layer following grid line g2. If the top edge is not shifted from grid line g0 but aligning grid line g1, the power routing PL1a can not be too wide, because a wider power routing PL1a may extend close to grid line g2 or even occupy grid line g2, leaving no room for signal routing along grid line g2. With the top edge offset of the invention, however, the offset offers an additional space. Thus a wider power routing PL1a (with width Wa) is allowed without interfering other routings of the same layer. For example, even a wider power routing PL1a extends over grid line g1, there is enough room for other routing of the same layer aligning grid line g2. A wider power routing can effectively reduce unwanted parasite effects (like parasite resistance). On the other hand, while arranging another power routing PL1b along the bottom edge, the power routing PL1b can be formed on another metal layer (i.e., a metal layer other than the metal layer applied for the power routing PL1a). It is understood that distribution of power routings of the invention is not limited to above embodiment.

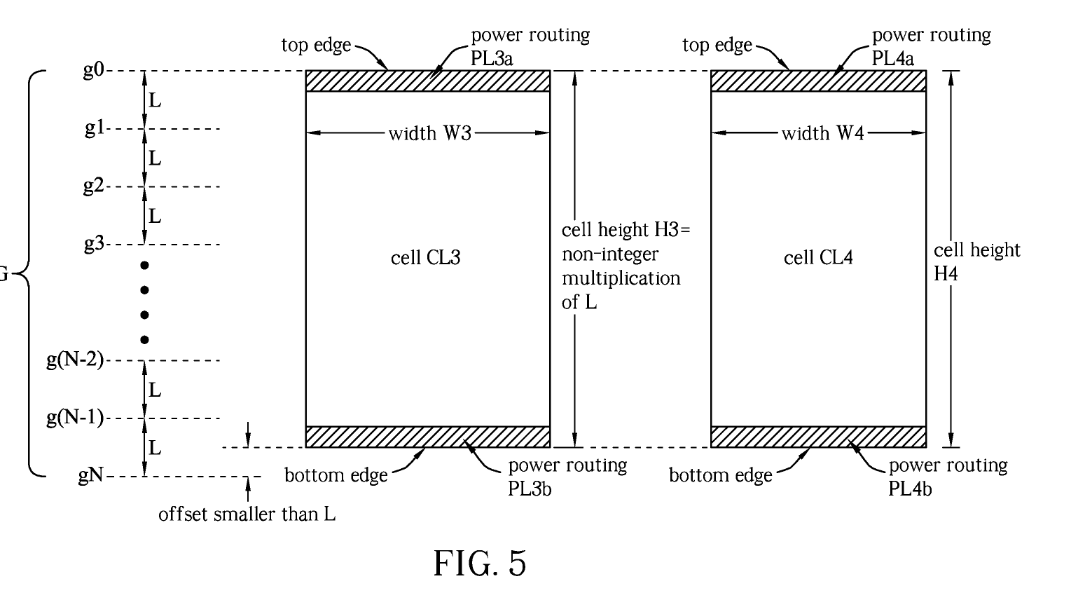

Please refer to FIG. 5. FIG. 5 illustrates another embodiment of the invention. In this embodiment, again, a basic length L is determined according to process applied for cells; for example, the basic length L can equal a routing track derived from design rules of the process. According to the basic length L, a virtual routing track grid G is built with grid lines g0, g1, . . . gN, wherein the basic length L defines distances between adjacent grid lines. In the embodiment of FIG. 5, however, a circuitry cell CL3 of the invention has its top edge aligning a grid line (e.g., grid line g0) and its bottom edge shifted from another grid line (e.g., grid line gN) by an offset smaller than L. In this way a cell height H3 of the cell CL3 is a non-integer multiplication of the basic length L. In a preferred embodiment, the offset equals L/2, such that the cell height H3 becomes an odd-integer multiplication of L/2. Similarly, power routings PL3a and PL3b are arranged along top and bottom edges of the cell CL3.

Applying the same design criterion described above, various cells, like a cell CL4 shown in FIG. 5, can be established. The cell CL4 can have its top/bottom edges aligning the top/bottom edges of the cell CL3, also power routings PL4a, PL4b of the cell CL4 can respectively align the power routings PL3a, PL3b of the cell CL3, such that the cells can be used together. By collecting cells of various functionalities, a cell library with cell heights equal to a non-integer multiplication of the basic length L is established. The cells shown in FIG. 3 and FIG. 5 of the invention can also be used together; for example, the layout of the cell CL3 can be flipped (mirrored) along horizontal axis, then the flipped cell can match layout arrangements of cells CL1/CL2, so they can be tiled side-by-side; that is, the power routings PL3b/PL3a can connect to power routings PL2a/PL2b and/or PL1a/PL1b to form a set of power trails. In addition, cells of FIG. 3 and FIG. 5 can be tiled horizontally, for example, the top edge of the cell CL3 can be set to align the bottom edge of the cell CL1.

To sum up, the invention discloses a design criterion to make cell height equal to a non-integer multiplication of a process basic length (e.g., a routing track). Comparing to cell design techniques of prior art, the invention can effectively reduce layout areas of cells, so the integration of ICs can be increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for establish a circuitry cell, comprising:
determining a basic length L according to semiconductor process applied for the cell;
while establishing the cell, making a layout height of the cell equal to a non-integer multiplication of the basic length L.

2. The method of claim 1, wherein making the layout height of the cell equal to a non-integer multiplication of the basic length L is making the layout height of the cell be an odd-integer multiplication of the basic length L.

3. The method of claim 1, wherein when determining the basic length L according to semiconductor process applied for the cell, determine the basic length L according to routing interval ruled in design rules of the semiconductor process.

4. The method of claim 1 further comprising:
before establishing the cell, building a routing track grid according to the basic length L such that the routing track grid has a plurality of grid lines with interval between adjacent grid lines equal to the basic length L;
and wherein making the layout height of the cell equal to a non-integer multiplication of the basic length L includes: aligning a bottom edge of a layout of the cell to one of the plurality of grid lines, and shifting a top edge of the layout of the cell from another one of the plurality of grid lines by an offset which is shorter than the basic length L.

5. The method of claim 4, wherein the offset equals L/2.

6. The method of claim 1 further comprising:
before establishing the cell, building a routing track grid according to the basic length L such that the routing track grid has a plurality of grid lines with interval between adjacent grid lines equal to the basic length L;
and wherein making the layout height of the cell equal to a non-integer multiplication of the basic length L includes: aligning a top edge of a layout of the cell to one of the plurality of grid lines, and shifting a bottom edge of the layout of the cell from another one of the plurality of grid lines by an offset which is shorter than the basic length L.

7. The method of claim 1, wherein the cell has at least two power routings for transmitting power, and the layout height of the cell is a distance between the two power routings.

8. A method for establish a circuitry cell library, comprising:
determining a basic length L according to semiconductor process applied for the cell library;
while establishing a cell of the cell library, making a layout height of the cell be a non-integer multiplication of the basic length L.

9. The method of claim 8, wherein making the layout height of the cell be a non-integer multiplication of the basic length L is making the layout height of the cell be an odd-integer multiplication of the basic length L.

10. The method of claim 8, wherein when determining the basic length L according to semiconductor process applied for the cell library, determine the basic length L according to routing interval ruled in design rules of the semiconductor process.

11. The method of claim 8 further comprising:
before establishing the cell, building a routing track grid according to the basic length L such that the routing track grid has a plurality of grid lines with interval between adjacent grid lines equal to the basic length L;
and wherein making the layout height of the cell be a non-integer multiplication of the basic length L includes: aligning a bottom edge of a layout of the cell to one of the plurality of grid lines, and shifting a top edge of the layout of the cell from another one of the plurality of grid lines by an offset which is shorter than the basic length L.

12. The method of claim 11, wherein the offset equals L/2.

13. The method of claim 8 further comprising:
before establishing the cell, building a routing track grid according to the basic length L such that the routing track grid has a plurality of grid lines with interval between adjacent grid lines equal to the basic length L;
and wherein making the layout height of the cell be a non-integer multiplication of the basic length L includes: aligning a top edge of a layout of the cell to one of the plurality of grid lines, and shifting a bottom edge of the layout of the cell from another one of the plurality of grid lines by an offset which is shorter than the basic length L.

14. The method of claim 8, wherein the cell has at least two power routings for transmitting power, and the layout height of the cell is a distance between the two power routings.

15. The method of claim 15, wherein power routings of different cells are aligned.

16. A circuitry cell comprising:
a plurality of semiconductor structures;
a predetermined substrate range covering the plurality of semiconductor structures; and a height of the substrate range equal to a non-integer multiplication of a basic length L.

17. The cell of claim 16, where in the basic length L equals a routing interval ruled in design rules of a semiconductor process applied for the cell.

18. The cell of claim 16, wherein the height of the substrate range equals an odd-integer multiplication of L/2.

19. The cell of claim 16, wherein the plurality of semiconductor structures include two power routings for transmitting power, the power routings are respectively placed align a top edge and a bottom edge of the substrate range, and the height of the substrate range is a distance between the two power routings.
